(19) United States
(12) Patent Application Publication
(10) Pub. No.: US 2018/0130281 A1
(43) Pub. Date: May 10, 2018

(54) Game Device

(71) Applicants: Adil Ben Moussa, Breda (NL); Mohammed Ben Moussa, Roosendaal (NL)

(72) Inventors: Adil Ben Moussa, Breda (NL); Mohammed Ben Moussa, Roosendaal (NL)

(21) Appl. No.: 15/568,995

(22) PCT Filed: Apr. 22, 2016
(86) PCT No.: PCT/NL2016/050284

§ 371 Date: Oct. 24, 2017

(30) Foreign Application Priority Data
Apr. 24, 2015 (NL) 2014715

(51) Int. Cl. G07F 17/32

(52) U.S. Cl. CPC G07F 17/3209; G07F 17/3216; G07F 17/3211

(57) ABSTRACT

The present disclosure relates to a game device. Such a game device may be flat and arranged on a foot, with a display oriented upward for players to look down onto representations shown on the display. However, the inventors of the present disclosure have taken up the challenge of conceiving a solution for the fact that these prior art game devices are considered to be very limited by players, in terms of number and of the nature of games that can be plaid thereon, and in terms of the number of players. According to the present disclosure, a new game device is proposed herein, that distinguishes over prior art configurations by the assembly of a carrier structure, a primary display in or on the carrier structure, and at least one secondary display, connected to the same carrier structure at a side of the primary display. More in particular, the at least one secondary display (5) is arranged at an oblique orientation relative to the primary display (4, 13, 15), recessed in an edge (19) of the carrier structure (3).

The present disclosure relates to a game device. In a prior art embodiment according to for example AT-506630, such game device may be flat and arranged on a foot, with a display oriented upward for players to look down onto representations shown on the display.

All players surrounding such a table like game device can see everything being displayed on and by a display of considerable size. For a number of games, this configuration may exhibit some advantages.

However, the inventors of the present disclosure have taken up the challenge of conceiving a solution for the fact that these prior art game devices are considered to be very limited by players, in terms of number and of the nature of games that can be plaid thereon, and in terms of the number of players. Even in prior art game devices having a touch screen to enhance the gaming experience, limitations are imposed on the number of players, who can actually simultaneously participate in playing a game, by the touch sensitivity of the display. For example, some games can not be played on such a game device, in particular if confidential information forms the heart of the game, for example when playing a sea battle based game (the position of ships needs to be kept secret from opposing players) or poker (some or all playing cards of one player are to be kept secret from opposing players during the course of the game). Also, a touch screen and even a big touch screen can normally detect only one touch at a time, whilst for some interactive games it may be important that the game device is capable of registering and processing a plurality of simultaneous touches. Additionally, reference is made here to prior art publication US-2010/151953, relative to which at least the features in the characterising portion of the appended independent claim are novel. Therein, a carrier structure comprises a broad rim in or on which a plurality of secondary displays is arranged around the primary display. Players are remote from the primary display to the extent that visibility of game information on the primary display may be impaired. The broadness of the rim not only impairs visibility, but also confidential information for a specific player may be seen by other players, because of the space between a player and his or her secondary display. A logical solution would be to provide a screen or the like, to reduce visibility of other players on any one of the secondary displays, but such a screen could or even would reduce visibility of a player behind the screen on the primary display.

Consequently, the inventors of the present invention have set out to conceive and develop an improved game device, according to which the above mentioned and/or other disadvantages and/or drawbacks of prior art configurations are remedied, or at least decreased.

To this end, according to the present disclosure, a new game device is proposed herein, that distinguishes over prior art configurations by the assembly of a carrier structure, a primary display in or on the carrier structure, and at least one secondary display, connected to the same carrier structure at a side of the primary display. More in particular, the at least one secondary display is arranged at an oblique orientation relative to the primary display, recessed in an edge of the carrier structure. Thereby, view on the display screen of the secondary display is already more restricted to a user at a playing position, with which the secondary display is associated. Other players will have no unobstructed view on the secondary display. Moreover, the rim of the carrier structure may be narrow, reducing problems with visibility of game information on the main primary display, but the height of the rim in which the secondary display is recessed allows for a shielding effect, as a consequence of the feature that the secondary display is recessed in the rim under an oblique orientation. Further, the elegantly narrow rim of the carrier structure results in considerably lower costs for manufacture, than the prior art's broad and coarse rim.

The game device may exhibit the feature of a cap associated with the at least one secondary display. Thereby sight on the screen of the secondary display can be further limited. This contributes to confidential information of or for a player at the secondary display in question, remaining confidential. With a cap at a secondary display obliquely recessed in the edge of the carrier structure, not only visibility on the secondary display is reduced for unauthorised players, but more importantly, a player's visibility on the primary screen is not impaired. In such an embodiment the game device may further exhibit the feature that a side of the cap facing the primary display is oriented generally upward. Additionally or alternatively, the cap may comprise side walls at opposing lateral sides of the secondary display. All these features enhance the game device in terms of confidentiality of displayed information intended for one specific player at the playing position with which the secondary display is associated.

Preferably the secondary display is arranged under an angle relative to the primary display, but the secondary display may also be parallel to the primary display. This novel configuration allows individual players to be shown their own confidential information, to input additional touch information, if the at least one secondary display is touch sensitive, and furnish a much more complete gaming experience, than was possible with prior art game devices.

In a particular embodiment, a game device according to the present disclosure may exhibit a feature that the primary display is arranged in an essentially horizontal orientation. Additionally or alternatively, the secondary display is arranged in an oblique orientation relative to a horizontal plane of the primary display. This contributes to improved representation of confidential information only to a player at a position around the device, where the secondary display is provided.

In a particular embodiment, a game device according to the present disclosure may exhibit an alternative or additional feature that the primary display has at least one circumferential shape from a group, comprising square, rectangular, triangular, pentagram, honeycomb, round, oval. The actual shape of a game device may correspond with a type of game or category of games to be played at the game device. The sheer number of possible shapes in any case contributes to the broadness of the range of products from a manufacturer.

In a particular embodiment, a game device according to the present disclosure may exhibit an alternative or additional feature of two or more secondary displays. Thus a player can play a game against a game computer, which may use the primary display for output, as well as against at least on other player. In such an embodiment, the game device may further exhibit a feature that secondary displays of a pair of the at least two secondary displays are arranged opposite one another, relative to the primary display. Thus the notion is emphasized, that the players at individual ones of the pair of secondary displays are adversaries.

In a particular embodiment, a game device according to the present disclosure may exhibit an alternative or additional feature that the carrier structure comprises a frame encompassing the primary display. Thereby, the primary display is well protected in the frame. In such an embodiment, the game device may further exhibit a feature that the frame comprises at least one accommodation for at least one secondary display, to define (a) position(s) of the secondary display(s) relative to the primary display. Additionally or alternatively, in such an embodiment with said frame, the game device may exhibit the feature that the frame comprises at least one user related attribute from a group, comprising: at least one cup or glass holder; at least one ashtray; a service button to call a waitress for drinks or maintenance personnel, and/or at least one game related attribute from a group, comprising: at least one joystick; at least one trackball; a coin slot with an associated coin tester; a numeric key pad; a letter keyboard. These aspects may serve to enhance the gamer player's sensation of being completely at ease, whereas the other category of game related attributes may serve to enable, facilitate and/or enhance the gaming possibilities.

In a particular embodiment, a game device according to the present disclosure may exhibit an alternative or additional feature of a game computer connected to the primary display and the at least one secondary display. The game computer can be interpreted as the heart of the device, and needs to be capable of driving the primary display and the at least one secondary display, and also receive, accept and process game input from players—if any of these displays allows game input from said players, for example from the touch sensitivity thereof, or the mouse, joystick, et cetera.

In a particular embodiment, a game device according to the present disclosure may exhibit an alternative or additional feature that at least one player position is defined along the circumference of the primary display, and at least one of the at least one secondary display is arranged at or near at least one of the at least player position. Thereby, a player position and a location of a secondary display may be correlated, to enhance the game experience or sensation, experienced by the players.

The game device may additionally or alternatively exhibit the feature that at least one of the primary display and the at least one secondary display comprises a touch area reserved for touch input from a user. Such a reserved area can replace other input means, such as a mouse, trackball and even a keyboard, when a user is able to write letters in or on the reserved area, which can be detected and recognised using appropriate programs running on a computer.

Following the above indications of embodiments of game devices according to the present disclosure in generic terms and expressions, corresponding with those of the appended claims, herein below will follow a detailed embodiment description in more specific terms and expressions to refer to aspects, features, elements, components and the like, wherein reference is made through reference numerals to the appended drawing. The appended drawing shows several preferred embodiments of game devices according to the present disclosure, where it is emphasized, that these embodiments are provided as strictly exemplary of possibilities in, of and/or for game devices according to the present disclosure. None of the features or functionalities of the embodiments in the appended drawings should be interpreted as limiting on the scope of protection for the present disclosure as defined in the appended claims, and in particular in the appended single independent claim. Even presently unforeseen alternatives and equivalents of features defined in the appended independent claim are encompassed within the scope of protection for the present disclosure. In the figures of the appended drawing, the same or similar aspects, elements, components, features, or functional assemblies and the like may be designated using the same or similar reference numerals. In the drawing:

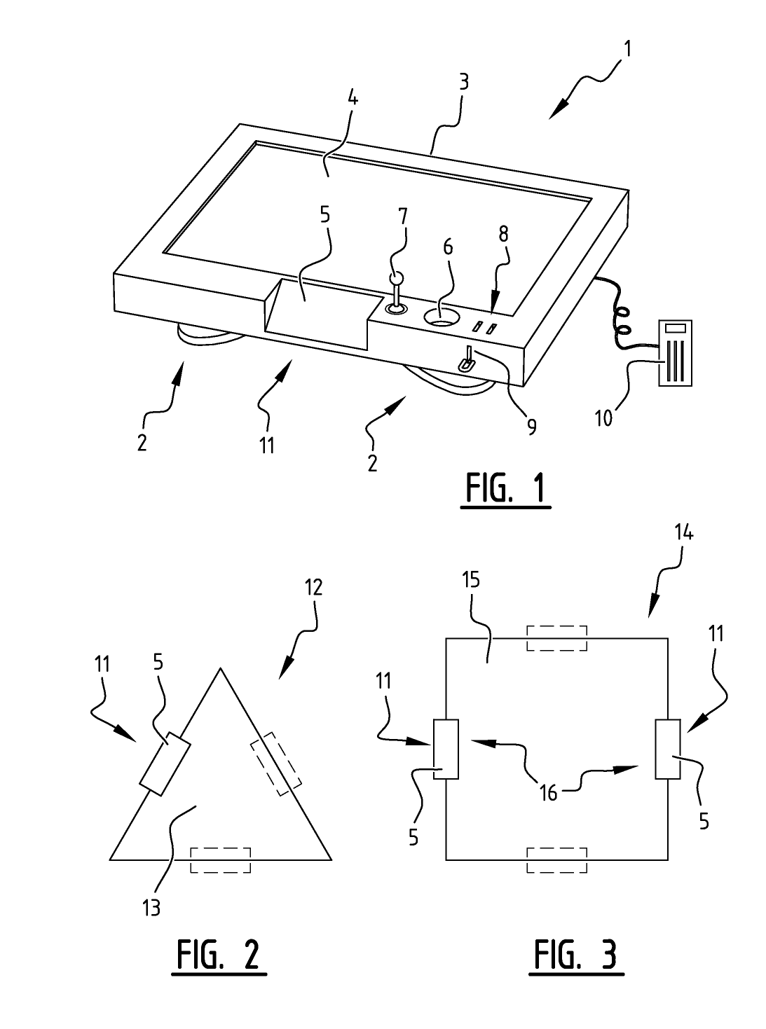

FIG. 1 shows an exemplary embodiment of a game device according to the present disclosure;

FIG. 2 shows an alternative exemplary embodiment of a game device according to the present disclosure;

FIG. 3 shows another alternative exemplary embodiment of a game device according to the present disclosure; and

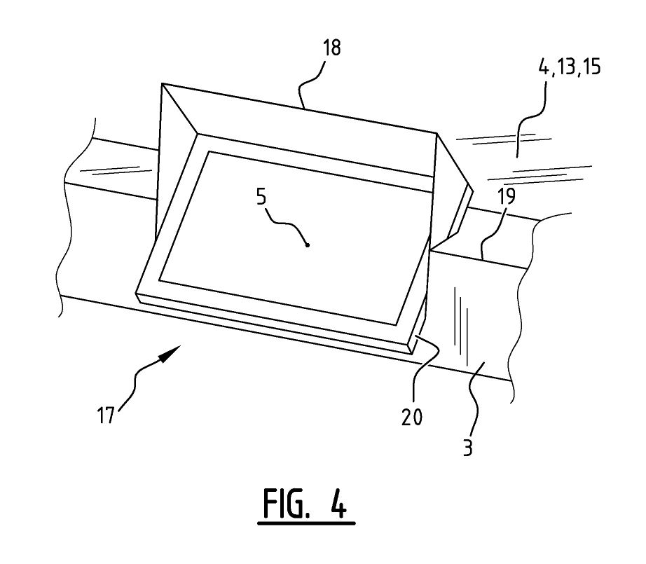

FIG. 4 show a detail of a further development relative to the preceding figures concerning the secondary display.

FIG. 1 shows an embodiment of a game table 1 as an embodiment of a game device according to the present disclosure. Game table 1 is set on a base 2 supporting a frame 3, with either or both of base 2 and frame 3 forming part of a carrier structure. A primary display 4 in the form of a touch sensitive display is encompassed by frame 3.

At one side of primary display 4, a secondary display 5 is set in frame 3. The secondary display 5 may be a touch sensitive display. More secondary displays 5 may be set in frame 3, along the same and/or different sides of the primary display 4. The secondary display 5 defines a player position 11, at which a selection of one or more of the following attributes may be provided in, on or at the frame 3: a user related attribute from a group, comprising: at least one cup or glass holder 6; at least one ashtray; a service button to call a waitress for drinks or maintenance personnel; a music selection input device, and the like. It is noted that at least some of these attributes may be embodied as icons shown on the primary or secondary display, selection by for instance tapping of which may cause a waitress or maintenance person to be called to the game device, or may initialise sound or music to be output, as part of the game being played and/or separate from the game. The game device may itself act as a juke box and control by a user with the music selection input device may influence the operation of the juke box application running on the game device, or the user may operate the music selection input device to have control over a separate music playing device. Additionally or alternatively, at the player position 11, a selection of one or more of the following attributes may be provided in, on or at the frame 3: at least one game related attribute from a group, comprising: at least one joystick 7; at least one trackball; a coin slot 8 with an associated coin tester and an associated coin rejection slot 9; a numeric key pad; a letter keyboard, and the like. In relation to a mouse or trackball it is noted that a portion of the primary or secondary display may be reserved for the input of touch and/or drag motion by a user, to function as a touch pad in a viewing area of the primary and/or the secondary display, instead of the mouse or trackball, and the like.

In the present particular embodiment of FIG. 1, the game device 1 exhibits a feature that the primary display 4 is arranged in an essentially horizontal orientation, and the secondary display 5 is arranged in an oblique orientation relative to a horizontal plane of the primary display 4, to more straight face a player at the player position 11.

In the embodiment of FIG. 1, the primary display 4 is rectangular. This is anticipated to constitute the most common configuration.

However, FIG. 2 exhibits a game device 12 having a player position 11 at secondary display 5 at a side of a triangular primary display 13. As indicated in relation to the embodiment of FIG. 1, additional player positions 11 and associated secondary displays 5 may be arranged along the same or other sides of the primary display 13, as indicated with dotted or dashed lines in FIG. 2.

FIG. 3 exhibits a game device 14 having a pair 16 of opposing player positions 11 at secondary displays 5 at opposing sides of a square primary display 15. As indicated in relation to the embodiment of FIG. 1, additional player positions 11 and associated secondary displays 5 may be arranged along the same or other sides of the primary display 15, in this case possibly even an additional pair of secondary displays 5 at opposing sides of the primary display 15, as indicated with dotted or dashed lines in FIG. 3.

In addition to the shapes of the primary display 4, 13, 15 according to FIGS. 1, 2 and 3 (rectangular, triangular and square) the primary display may have any arbitrary shape, such as a pentagram, honeycomb, round, oval, et cetera.

In the embodiment of FIG. 4, showing a detail of a game device 17 according to the present disclosure, a cap 18 is associated with the at least one secondary display 5. The cap 18 has a side facing the primary display (4, 13, 15), which is oriented generally upward. Together with side walls of cap 18, it is ensured that any other player than the one at a particular playing position 11 can hardly see anything of the information being displayed on the secondary display 5 for the benefit of the player at that specific playing position 11. A line of sight on the primary screen can remain unimpeded by such a screen, as a direct consequence of the recessed position and the oblique orientation of the secondary display 5 in the edge 19 of the frame 3.

It is further noted that since secondary display 5 is set in frame 3, at an oblique orientation and recessed into an edge 19 of frame 3, the assembly is sturdy and robust. Secondary display 5 is encompassed by a secondary frame 20, which is or at least may appear to be unitary with frame 3. Cap 18 may be of the same material as the frame 3, and secondary frame 20 may also be of that same material, for example steel or very durable plastic, and is preferably completely opaque, in order not to allow other players to see what is shown on secondary display 5 and withstand tampering.

In most specific embodiments, game devices according to the present disclosure may comprise or be connected to a game computer 10, as shown in FIG. 1, but which may be provided in any other embodiment, where the game computer is connected to the primary display 4 and to the at least one secondary display 5. The game computer 10 can be interpreted as the heart of the game device 1, and needs to be capable of driving the primary display 4 and the at least one secondary display 5, and also receive, accept and process game input from players—if any of these displays allows game input from said players, for example from the touch sensitivity thereof, or the mouse, joystick 7, keypad, keyboard, et cetera.

After the foregoing indications of embodiments of the present disclosure in generic and more specific terms and expressions, the skilled person will have been confronted with a full and complete disclosure. The scope of protection for the present disclosure encompasses any embodiment having at least the features according to the appended independent claim, including obvious alternatives, if any. For instance, the game device may have any shape or form, to be determined based on the shape of form of the frame and/or of the primary display. The cap may be omitted. Secondary display 5 may be apart from but connected to frame 3, for instance in a satellite configuration on an arm or the like, where such an arm may even be adjustable or bendable, et cetera. Thus it is noted that a scope of protection for the present disclosure is only limited by the appended independent claim including alternatives.

1. Game device, comprising:
a carrier structure;
a primary display in or on the carrier structure; and
at least one secondary display, connected to the same carrier structure at a side of the primary display,
wherein the at least one secondary display is arranged at an oblique orientation relative to the primary display and is recessed in an edge of the carrier structure.

2. Game device according to claim 1, wherein a cap is associated with the at least one secondary display.

3. Game device according to claim 2, wherein a side of the cap facing the primary display is oriented generally upward.

4. Game device according to claim 2, wherein the cap comprises side walls at opposing lateral sides of the secondary display.

5. Game device according to claim 1, where in the primary display is arranged in an essentially horizontal orientation.

6. Game device according to claim 1, wherein the primary display has at least one circumferential shape from a group, comprising square, rectangular, triangular, pentagram, honeycomb, round, oval.

7. Game device according to claim 1, comprising two or more secondary displays.

8. Game device according to claim 7, wherein secondary displays of a pair of the at least two secondary displays are arranged opposite one another, relative to the primary display.

9. Game device according to claim 1, wherein the carrier structure comprises a frame encompassing the primary display.

10. Game device according to claim 9, wherein the frame comprises at least one accommodation for at least one secondary display.

11. Game device according to claim 9, wherein the frame comprises at least one user related attribute from a group, comprising: at least one cup or glass holder; at least one ashtray; a service button to call a waitress for drinks or maintenance personnel; a music selection input device.

12. Game device according to claim 9, wherein the frame comprises at least one game related attribute from a group, comprising:
at least one joystick;
at least one trackball;
a coin slot with an associated coin tester;
a numeric key pad;
a letter keyboard; and
a music selection input device.

13. Game device according to claim 1, further comprising a game computer connected to the primary display and the at least one secondary display.

14. Game device according to claim 1, wherein the primary display comprises a touch screen.

15. Game device according to claim 1, wherein the at least one secondary display comprises a touch screen.

16. Game device according to claim 1, wherein at least one player position is defined along the circumference of the primary display, and at least one of the at least one secondary display is arranged at or near at least one of the at least player position.

17. Game device according to claim 1, wherein at least one of the primary display and the at least one secondary display comprises a touch area reserved for touch input from a user.
